(19) United States
(12) Patent Application Publication
(10) Pub. No.: US 2004/0231241 A1
(43) Pub. Date: Nov. 25, 2004

(54) Pot cover

(75) Inventor: Alban-Josse Lepoutre, Roubaix (FR)

Correspondence Address: John S. Egbert, Harrison & Egbert, 7th Floor, 412 Main Street, Houston, TX, 77002, US

(73) Assignee: CLAYRTON'S, Societe Anonyme, Roubaix (FR)

(21) Appl. No.: 10/847,956

(22) Filed: May 18, 2004

(30) Foreign Application Priority Data
May 22, 2003 (FR) 03/06147

(51) Int. Cl. A01G 9/02

(52) U.S. Cl. 47/72

(57) ABSTRACT

A pot cover includes a bottom and a lateral envelope. The lateral envelope is in the form of a flat-foldable elastic body and is vertically extendable, over variable height and adjustable to the height of the pot. The elastic body includes moreover an edge supporting at least fastening mechanism to maintain the pot cover over the pot, in a deployed position.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to a pot cover, useable in various fields and notably in the floral field.

### BACKGROUND OF THE INVENTION

Florists use widely pleated holders for masking flowerpots when displayed for sale, such covers may be made of paper or of plastic, in the form of a sleeve to suit different possible sizes or shapes of flowerpots. The object of the pleating is to adapt the cover to different sizes of flowerpots by the possible extension in diameter. This pleating is parallel to the height of the flower pot, i.e. in the vertical direction of the sleeve.

These pleated sleeves do not confer any aesthetic effect and their sole advantage consists in masking, at low cost, the color of the flowerpot. This limited decorative function is such that the consumers usually dispose of this pot cover after purchase, to place the flowerpot in a holder more pleasant visually. This type of decoration has therefore a usage limited exclusively to display for sale, and very short lifetime.

The object of the invention is to remedy these main difficulties, i.e. to suggest a flowerpot of economical manufacture, enhanced aesthetics and capable of long-term usage after purchase by the consumers, let alone for decorative applications other than those of a pot cover.

### BRIEF SUMMARY OF THE INVENTION

According to the invention, the pot cover, notably intended to mask a pot of flowers or similar, including a bottom and a lateral envelope, is characterized in that the lateral envelope is in the form of a flat-foldable elastic body and vertically extendable over variable height and adjustable to the height of said pot or similar, said elastic body including moreover an edge supporting at least fastening means enabling to maintain the pot cover over the pot or similar, in deployed position.

Other characteristics and advantages of the invention will appear from the following description in combination with the appended drawings, given only for non-limiting exemplification purposes.

### BRIEF DESCRIPTION OF THE SEVERAL VIEWS OF THE DRAWINGS

FIG. 1 represents a side view of a pot cover according to a first embodiment of the invention, with a characteristic accordion-like structure.

FIG. 2 illustrates the pot cover of FIG. 1 in folded position, flat and as a top view.

FIG. 3 shows other possible embodiments for the pot cover, with a characteristic accordion-like structure.

FIG. 4 shows examples of structures for the bottom of the pot cover.

FIG. 5 shows a view from beneath of a pot cover according to a second embodiment of the invention with a characteristic cut out structure.

FIG. 6 shows a top view of the pot cover illustrated on FIG. 5.

FIG. 7 is a perspective view of another embodiment of pot cover with a cutout structure.

### DETAILED DESCRIPTION OF THE INVENTION

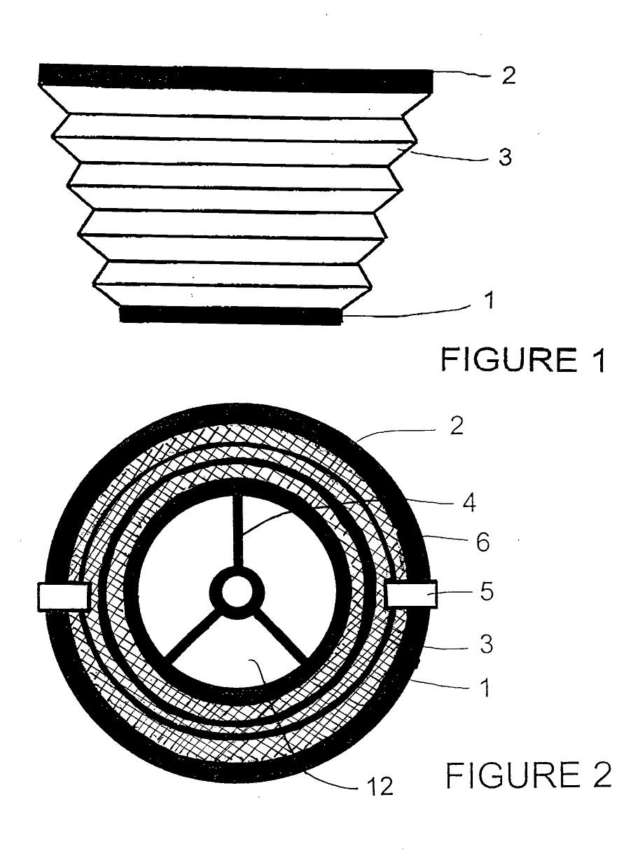

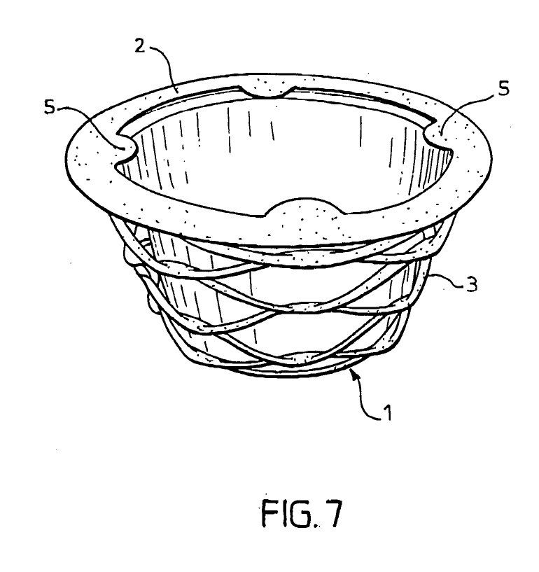

More precisely, FIG. 1 or FIG. 7 shows the pot cover, of the invention, ready to receive a pot or similar. Such a pot cover consists of a bottom 1, notably serving as a support for said pot, and of an edge 2 forming the upper end of the pot cover element.

The bottom 1 of the pot cover is connected to the edge 2 by an elastic body 3 connecting said edge and said bottom to one another.

By elastic body is meant a body which has the property of resuming, partially or totally, its flat shape, after losing it by deployment.

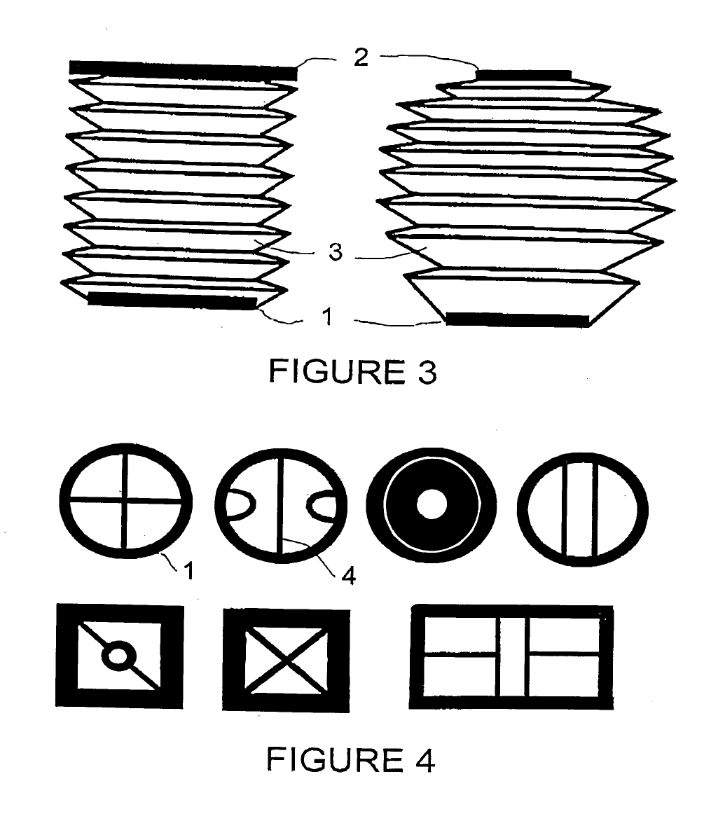

The elastic body 3 is flat foldable, so that the pot cover may be folded simply by pressing vertically on the edge 2. Such a minimum space configuration is illustrated by the top view of FIG. 2 or by the underside and top views of FIGS. 5 and 6.

Besides, said body 3 is shaped so that the pot cover is deployable vertically over variable height, and adjustable to the height of the port or similar, as shown notably on FIG. 1 or FIG. 7.

By folding or vertical deployment is meant any extension or contraction of the elastic body 3 along an axis perpendicular to an axis formed by the bottom 1 of the pot cover.

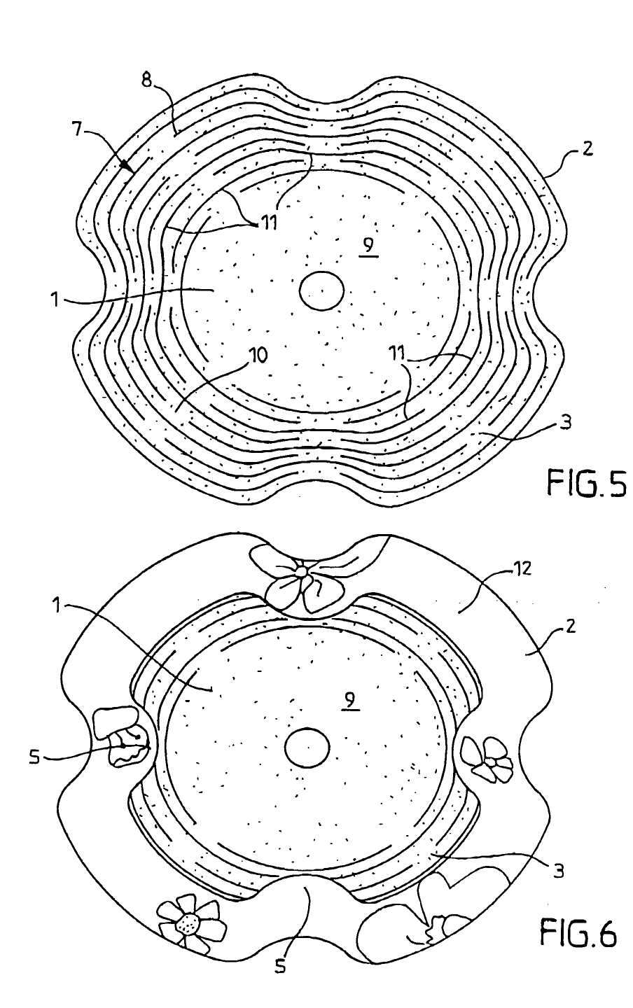

According to a first embodiment, as illustrated on FIGS. 2 and 4, the elastic body 3 shows an opening in the form of at least one orifice 12,

According to a second embodiment non illustrated, the elastic body 3 has internally a sealed pocket in order to form with said elastic body 3 a double watertight wall.

Said plastic pocket comes down to the bottom of the pot cover when deployed and may go up to the top of the pot cover or simply halfway up. It may be glued, sewed, stapled, etc. to the walls of the pot cover, either over the whole diameter or in some points only.

According to an embodiment, as illustrated on FIGS. 1 to 3, the elastic body 3 is in the form of an accordion-like pleated wall.

In particular, said pleated wall 3 defines an envelope of various shapes, pleated parallel to the base of the pot, i.e. in the horizontal direction of the envelope.

Several materials may be used to make the pleated body 3, notably paper, cardboard, plastic, non-woven fabrics, textiles or any other material which may be pleated or given an accordion-like configuration, without breaking.

Advantageously, the pleated body consists of a lightweight colored paper treated to resist moisture and/or hydrophobic.

The material forming the pleated body is fastened to the edge 2 and to the bottom 1 by gluing, stapling, thermal welding or any other technique usable according to the material employed. The material, notably its nature, its thickness and its characteristics, is selected in relation to the mechanical constraints which should be sustained by the pot cover, in particular when the latter is intended for hanging from an arched handle connected to the edge 2.

The accordion-like pleated body, as illustrated on FIG. 2, may be reinforced mechanically by intermediate rings 6 coaxial with the edge 2 and the bottom 1 or by longitudinal reinforcement bands connecting the bottom 1 and the edge 2. Said bands may consist of the same material as the body or of more resistant elements such as, for example, reinforced textiles.

Advantageously, and in order to guarantee easy accordion-like folding of the pot cover, the pleated body is glued to a reinforcement composed of a metal wire connecting the bottom 1 and the edge 2 by performing several spires between both elements. Thus, the accordion-like pleating effect varies according to the number of spires formed.

The bottom 1 and the edge 2 may be manufactured with sufficiently rigid and resistant metal wires, and whereof the diameter is adapted to the type of pot to be contained in the pot cover.

According to the invention, the bottom 1 and the edge 2 are advantageously dimensionally stable.

The pot cover according to the invention has, moreover, fastening means 5 for the elastic body 3, in order to maintain the pot cover on the pot in deployed position, during usage.

Advantageously, the fastening means 5 consist of at least one thin elastic tab, made of plastic or of metal, flexible as the pot runs through it, and able to resume its initial potion once the pot is inside the pot cover.

Said fastening means 5 may consist of at least one hook, one plastic tab, one metal rod, one claw or any other device preventing the pot cover from folding back once the pot has been inserted inside.

In an advantageous embodiment, at least two fastening elements shall be placed diametrically opposite, as illustrated on FIG. 2. Nevertheless, it may be contemplated to increase their number in order to distribute 3 to 6 fastening evenly.

The truncated shape of the pot cover, illustrated on FIG. 1, is significant of the vast majority of the flower or plant pots sold by florists, and garden centers. However, other shapes may be contemplated, notably for parallelepiped, hemispherical pots, etc. Two other shapes, which may be realized, for example, are illustrated on FIG. 3.

The bottom 1 supporting the weight of the pot may be partially open, and shaped to let through the water from the pot. In order to sustain the weight of said pot, the bottom 1 has supports 4, advantageously in the form of rods or crossbeams, which crossbeams are made of the same material as the bottom.

Different configurations are possible for those supports, some of them are shown on FIG. 4, notably for pot cover of parallelepiped shapes.

Such a pot cover according to the invention enables to use traditional cups, which prevent any water overflow from the pot cover, these cups will be, for instance, placed under the bottom 1 and consequently under the pot.

According to an embodiment of the invention, as illustrated on FIG. 2, a pot cover, intended for receiving a pot plant or similar, exhibits the following features:

The bottom 1 consists of a metal wire central ring of 2 millimeters in diameter, with only three back-up radial rods 4, of same diameter and of same nature, connecting the periphery of the base of the body 3 to the central ring, defining a base of 11 centimeters in diameter, for instance.

The upper edge 2 of the body 3 also consists of a circular metal wire of 2 millimeters, defining a diameter of 17.5 centimeters, for instance.

The pleated body 3 consists for example of a colored non-woven fabric, impregnated with synthetic latex, in order to enhance its resistance to moisture and to confer certain hydrophobia to the material. Said non-woven fabric may be printed by flexography before the folding process, in order to bring additional decoration to the pot cover. The pleated body is glued onto itself after winding around the edge 2 and the bottom 1 in order to mask both rigid structures.

The material of the pleated body is sufficiently flexible so that the pot cover is trouble-free foldable flat. The material employed is however sufficiently resistant so that the device may be folded and deployed numerous times without breaking.

The height of the pot cover deployed, between the bottom 1 and the edge 2, is 17 centimeters, for instance.

For easy folding and to confer to the whole a pleasant shape, the edge 2 and the bottom 1 in the form of rings are made of the same metal element, spiral-wound over the height of the pot cover, by forming in this precise example, 7 reinforcement spires for the structure.

On the edge 2 are provided two fastening elements 5, diametrically opposed, consisting for example of thin metal rods, 1 millimeter in diameter and 2 centimeters in length, enabling to lock the pot cover in deployed position on the pot. Such fastening means are held firmly on the edge 2 to prevent the pot cover from pivoting inwardly when inserting the pot. Said fastening means is flexible in order to be deformed when inserting the pot and to resume its original shape, so-called locked position, thereby capturing the pot when the latter is inside the pot cover.

The example of this pot cover thus manufactured receives pots of several dimensions and more particularly those whereof the diameter at the base is smaller than or equal to 10 centimeters and the diameter at the apex ranges between 13.5 and 17 centimeters, for a pot height ranging between 10 and 15 centimeters. The aesthetic of the assembly and the decorations printed enable advantageous display of the pot plants for sale, at reduced production cost.

The advantages of the foldable pot cover according to the invention are numerous. Indeed, such an element is simultaneously decorative and functional, its accordion-like shape is pleasant and aesthetically recognized in many countries.

Such a pot cover may be used in the long-term for its primary masking function of the plant support as well as a decoration element. Folding and deploying such a pot cover and placing the pots inside are extremely easy. These covers are functionally better suited than the pleated sleeves known and used by florists.

The pot cover in flat folded position, during storage, has very small space requirements. Finally, such a pot cover is industrially easy to manufacture and of cost sufficiently low so that its usage may be generalized.

One may also contemplate, by suitable prints and the creation of various shapes, to produce numerous different pot covers following the same functional design.

Naturally, several variations of the foldable pot cover may be realized without departing from the framework of the invention, and notably a pot cover intended to hang from an arched handle or any suspension device connected to the bottom 1 and guided by the edge 2.

It may be contemplated, for instance to hang the pot cover using a small cord attached to the bottom 1 at two points, diametrically opposed, which small cord would run through positioning rings arranged on the edge 2, also in two points, diametrically opposed.

The shapes, the sizes and the constitutive materials of the pot covers may be quite diverse. Similarly, there may be contemplated various graphics, colors and decorations, without departing from the framework of the invention.

According to a second embodiment, as illustrated on FIGS. 5 to 7, the elastic body 3 is in the shape of a cut-out wall, capable of being deployed also like an accordion, but whereof the bellows would be open or as honeycombs.

The elastic body 3, in such a case, may be obtained using a semi-rigid sheet 7, of plastic or of cardboard, for example, whereof the periphery 8 corresponds to the shape of said edge 2, whereof the central portion 9 corresponds to the shape of said bottom 1, and whereof the intermediate portion 10 has discontinuous cut-outs 11, globally circular and concentric, to form the so-called honeycombed wall, as illustrated on FIG. 7, notable as a truncated cone.

Besides, to form said edge 2, a rigid or semi-rigid crown 12 may be interconnected at the periphery 8 of said sheet 7, a crown at which said fastening means 5 may be provided, advantageously in the thickness thereof, gripping on the pot to be hidden.

In another variation, not represented, the body may be obtained using a semirigid sheet, made of plastic or of cardboard, for example, whereof the periphery corresponds to the shape of said edge, whereof the central portion corresponds to the shape of said bottom, and whereof the intermediate portion has a helicoid cut-out to build up a wall capable of being deployed into a coil, notable a truncated cone.

Besides, all the other features and details described in connection with the first embodiment may also be contemplated.

Obviously, the invention is not limited to the embodiments described and represented as examples, but it also includes all the technical equivalents as well as their combinations.

1. A pot cover, notably intended to mask a pot of flowers or similar, said pot cover comprising:
a bottom and a lateral envelope, wherein said lateral envelope is a flat-foldable elastic body and vertically extendable, over variable height and adjustable to a height of said pot, wherein said elastic body is comprised of an edge supporting at least one fastening means to maintain a deployed position over the pot.

2. A pot cover according to claim 1, wherein the bottom has an opening comprised of at least one orifice.

3. A pot cover according to claim 1, wherein the elastic body has internally a sealed pocket in order to form with said elastic body a double watertight wall.

4. A pot cover according to claim 1, wherein the bottom and the edge are rigid.

5. A pot cover according to claim 1, wherein the elastic body is comprised of an accordion-like pleated wall, defining an envelope of various shapes, pleated parallel to the base of the pot, in a horizontal direction of the envelope.

6. A pot cover according to claim 5, wherein the pleated wall is reinforced by at least one additional structure.

7. A pot cover according to claim 6, wherein the pleated wall is reinforced by a helicoid rigid structure connecting the bottom and the edge, wherein the rigid helicoid structure is comprised of a metal wire.

8. A pot cover according to claim 6, wherein the rigid reinforcement structure, the bottom and the edge are comprised of a same material and produced with a single length of said material shaped continuously.

9. A pot cover according to claim 6, wherein the additional reinforcement structure comprises at least one flexible band connecting directly the bottom and the edge.

10. A pot cover according to claim 1, wherein the elastic body is comprised of a semi-rigid sheet, wherein a periphery thereof corresponds to the shape of said edge, wherein a central portion thereof corresponds to the shape of said bottom, and wherein an intermediate portion thereof has discontinuous cut-outs, globally circular and concentric, forming a wall deployed as a honeycomb.

11. A pot cover according to claim 1, wherein the elastic body is comprised of a semi-rigid sheet, wherein a periphery thereof corresponds to the shape of said edge, wherein a central portion thereof corresponds to the shape of said bottom, and wherein an intermediate portion has a helicoid cut-out forming a wall deployed as a coil.

12. A pot cover according to claim 1, wherein said body is comprised of paper, fabric, non-woven fabric, plastic or any other material allowing accordion-like folding or capable of being shaped as such.

13. A pot cover according to claim 12, wherein the body is comprised of a moisture-resistant material.

14. A pot cover according to claim 1, wherein the bottom has a fastening system enabling suspension, guided by the edge.
